(19) United States
(12) Patent Application Publication
(10) Pub. No.: US 2026/0097971 A1
(43) Pub. Date: Apr. 9, 2026

(54) SYSTEM AND METHOD FOR SEPTAGE TREATMENT WITH REAL-TIME OPTIMIZATION AND PREDICTIVE MAINTENANCE

(71) Applicant: Water, Sanitation and Hygiene Institute (WASH Institute), Tamil Nadu (IN)

(72) Inventor: Arumugam Pillai Kalimuthu, Tamil Nadu (IN)

(73) Assignee: Water, Sanitation and Hygiene Institute (WASH Institute), Tamil Nadu (IN)

(21) Appl. No.: 18/980,714

(22) Filed: Dec. 13, 2024

(30) Foreign Application Priority Data
Oct. 9, 2024 (IN) IN 202441076409

(51) Int. Cl. C02F 1/00; C02F 11/127; C02F 11/14

(52) U.S. Cl. CPC C02F 1/008; C02F 11/127; C02F 11/14; C02F 2209/001; C02F 2209/006; C02F 2209/36; C02F 2209/40

(57) ABSTRACT

The present invention relates to a system and method for treating septage utilizing advanced optimization and machine learning models. The system comprises multiple components, including a coagulation tank, a centrifuge module, and a filtration unit, all controlled by a processing unit that dynamically adjusts operational parameters based on real-time data. The method involves analyzing septage characteristics, optimizing chemical dosing, separating solids and liquids, and refining filtration processes to remove contaminants. The system also features predictive maintenance capabilities for critical components, ensuring efficient, continuous operation. As such, it provides a highly adaptive, intelligent solution for efficient septage treatment while ensuring compliance with water quality standards.

### TECHNICAL FIELD

The present invention relates to a system and method for septage treatment, and more particularly to a system that utilizes automation for optimizing chemical dosing, filtration processes, and predictive maintenance in the treatment of septage.

### BACKGROUND

In the rapidly evolving landscape of waste management and environmental sustainability, the efficient treatment of septage has become a critical challenge. With increasing urbanization and population growth, the demand for effective septage treatment systems has risen sharply. Advanced technologies, including automation and AI, have emerged as potential solutions to improve the efficiency, reliability, and scalability of septage treatment processes.

Conventional methods available for septage treatment largely rely on manual operation and basic filtration techniques. These methods are often inefficient, time-consuming, and prone to errors. Problems such as inaccurate chemical dosing, irregular maintenance, and suboptimal filtration result in inconsistent treatment quality and higher operational costs. Additionally, the lack of real-time monitoring and predictive maintenance often leads to equipment failures and system downtime, further hampering the overall efficiency of the process.

Furthermore, existing systems merely focus on basic filtration and sludge separation without leveraging advanced technologies for optimization. They lack intelligent control mechanisms that can adapt to varying septage compositions, predict maintenance needs, or ensure precise chemical dosing, which is essential for maintaining treatment standards and reducing operational costs. These limitations prevent conventional systems from meeting the growing demand for reliable, scalable, and efficient septage treatment solutions.

One of the major limitations in current septage treatment systems is the inability to handle variable sludge composition efficiently. Septage from different sources can vary significantly in terms of thickness, chemical composition, and contaminants, which makes manual dosing of treatment chemicals inaccurate and inefficient. Existing systems do not have the capability to dynamically adjust to these variations, often leading to either overuse or underuse of chemicals, which impacts both the effectiveness of the treatment and the cost efficiency of the process.

Another critical issue is the lack of predictive maintenance mechanisms in conventional systems. Septage treatment involves multiple filtration and mechanical stages, each of which is subject to wear and tear over time. However, without real-time monitoring and predictive analytics, failures in equipment such as pumps, centrifuges, or filtration units are often detected only after they have caused significant downtime and operational disruptions. This not only increases maintenance costs but also results in untreated or poorly treated effluents being released into the environment. Addressing these technical challenges requires a system capable of monitoring, predicting, and optimizing the treatment process in real time.

As a result, there is a need for a system and method to integrate AI and machine learning models for automated chemical dosing, real-time filtration adjustments, and predictive maintenance, thereby enhancing the overall efficiency, reliability, and scalability of septage treatment.

Further limitations and disadvantages of conventional and traditional approaches will become apparent to one of skill in the art, through the comparison of described systems with some aspects of the present disclosure, as set forth in the remainder of the present application and with reference to the drawings.

### SUMMARY

In an embodiment, a method for septage treatment is disclosed. The method includes extracting septage from a septic tank using a sewage pump and passing it through a screen filter to separate sludge from the liquid. Treatment chemicals are then applied to the sludge via a chemical dosing unit, with the dosage optimized using an AI-based machine learning model based on real-time analysis of sludge properties. Subsequently, the sludge undergoes processing in a centrifuge to separate solids from liquids, while the separated liquid is further filtered in a solid-liquid separation unit. Continuous monitoring of both filtration and chemical dosing stages is conducted, with AI modules dynamically adjusting the processes based on real-time data. The method also incorporates predictive maintenance for the pumps, centrifuges, and filters, utilizing AI to forecast potential failures and suggest maintenance schedules, thereby ensuring system efficiency and minimizing downtime. As such, the treated effluent is chlorinated, and AI-driven sensors verify compliance with water quality standards.

In an embodiment, a system for septage treatment is disclosed. The system comprises a sewage pump configured to extract septage from a septic tank and supply it to a screen filter that separates sludge from the liquid. A coagulation tank is connected to the screen filter, where treatment chemicals are applied to the sludge through a chemical dosing unit. The dosage is controlled by an AI-based machine-learning model that optimizes chemical usage based on real-time analysis of sludge characteristics. A centrifuge, connected to the coagulation tank, separates solids from liquids, with the separated liquid processed in a solid-liquid separation unit for further filtration. The system also includes AI-driven monitoring and control mechanisms that adjust filtration efficiency and chemical dosing based on real-time data. Additionally, a predictive maintenance module monitors the performance of pumps, centrifuges, and filters, anticipating failures and optimizing maintenance schedules. The system features a chlorination unit for disinfecting the treated effluent, with AI sensors ensuring that the water quality meets established standards.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 illustrates a block diagram of the septage treatment system, configured to implement various embodiments of the present invention.

FIG. 2 illustrates the architecture of a processing unit of the present system, in accordance with an embodiment of the present invention.

FIG. 3 is a flowchart that illustrates a method for treating septage using an AI-driven optimization process, in accordance with an embodiment of the present invention.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The present invention addresses the limitations of conventional septage treatment systems, which often suffer from inefficiencies, manual operations, and inadequate monitoring. The system leverages AI-driven automation to optimize chemical dosing based on real-time sludge composition, ensuring a precise treatment that adapts to varying conditions. Further, the system incorporates advanced filtration techniques that improve solid-liquid separation, enhancing the overall quality of the treated effluent. Additionally, predictive maintenance features monitor equipment health and performance, allowing for timely interventions and reducing downtime. Such an approach provides a comprehensive and efficient solution for modern septage treatment challenges, ensuring compliance with environmental standards while minimizing operational costs.

The primary objective of the present system is to enhance the efficiency and effectiveness of septage treatment processes by integrating advanced AI and machine learning technologies. To achieve this, the present invention aims to optimize chemical dosing and filtration operations based on real-time analysis of sludge properties, thereby improving treatment outcomes and reducing operational costs. The system's objective is to enable automated monitoring and dynamic adjustments throughout the treatment process, ensuring consistent quality of the treated effluent. Additionally, the present disclosure seeks to implement predictive maintenance strategies that minimize equipment downtime and maintenance costs, allowing for a more reliable and sustainable septage treatment solution. Furthermore, it aims to ensure compliance with environmental standards by incorporating AI-driven quality monitoring systems that continuously assess the treated effluent's safety and effectiveness.

The present invention introduces a septage treatment system designed to optimize the entire treatment process through advanced automation and real-time monitoring. Unlike conventional systems, which rely heavily on manual operations and basic filtration methods, the present solution utilizes machine learning modules to analyze sludge characteristics and dynamically adjust chemical dosing, ensuring precise treatment tailored to varying septage compositions. Further, the integration of predictive maintenance capabilities, which continuously monitor equipment performance and predict potential failures, thus minimizing downtime and maintenance costs. Additionally, the system features a multi-stage filtration process that incorporates advanced technologies, such as ultrafiltration membranes and dual media filters, to enhance solid-liquid separation and improve the quality of the treated effluent. By combining these elements, the invention not only enhances operational efficiency but also ensures compliance with environmental regulations, providing a sustainable and effective solution for modern waste management challenges.

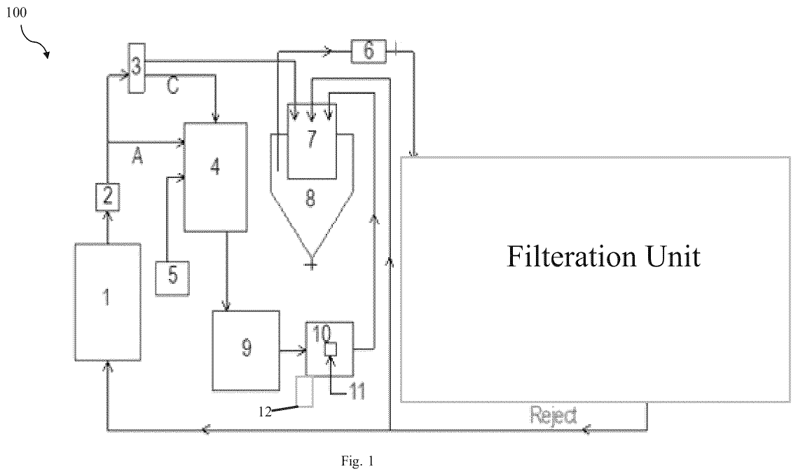

FIG. 1 illustrates a block diagram of the AI-driven septage treatment system 100, configured to implement various embodiments of the present invention. System 100 comprises a sewage pump (2), a screen filter (3), a coagulation tank (4), a chemical dosing unit (5), a centrifuge module (6), a solid-liquid separation unit (7), a secondary collection tank (8), a chlorination unit (9), a processing unit (10) equipped with AI-driven optimization, a communication network (11), a user interface (12), and filtration unit. Each component is interconnected to enable seamless data exchange and operational integration for optimized treatment.

The sewage pump (2) extracts septage from a septic tank (1) and supplies it to the screen filter (3). The screen filter separates rejected sludge from filtered liquid. The filtered liquid is directed to the solid-liquid separation unit (7) for further processing, while the rejected sludge is sent to the coagulation tank (4) for chemical treatment. Real-time data regarding sludge properties is fed into the processing unit (10) to adjust operations dynamically, optimizing chemical dosing and separation efficiency. Further, the extracted waste is sent to the filtration unit for further processing and all processes are communicated via communication network 11 using user interface 12.

The coagulation tank (4), integrated with the chemical dosing unit (5), enhances the treatment process by applying coagulants and flocculants to the sludge based on real-time analysis. The AI-driven processing unit (10) analyzes the characteristics of the sludge, such as organic content and nutrient levels, dynamically adjusting chemical dosages to improve treatment efficiency and reduce chemical waste. The treated sludge is then directed to the centrifuge (6) for further solid-liquid separation.

The solid-liquid separation unit (7) employs advanced filtration technologies, such as ultrafiltration membranes, to refine the filtered liquid and ensure high-quality effluent. The processing unit (10), utilizing machine learning models, continuously monitors operational parameters, including filtration flow rates, and adjusts them based on real-time contaminant levels. This results in optimized filtration performance and adherence to environmental standards.

The sewage pump (2) is designed to handle viscous sludge and operate under various conditions while maintaining reliable flow rates. The processing unit (10) monitors its performance, triggering maintenance alerts when anomalies are detected. This predictive maintenance capability helps in reducing downtime and improving system efficiency.

The screen filter (3) separates the incoming septage into two streams rejected sludge and filtered liquid. The filter's operational parameters, such as mesh size and flow rate, are adjusted in real-time based on data from the processing unit (10) to prevent clogging and optimize filtration. The rejected sludge is sent to the coagulation tank (4) for chemical treatment, while the filtered liquid proceeds to the solid-liquid separation unit (7).

The coagulation tank (4) plays an important role in the chemical treatment process by receiving rejected sludge from the screen filter (3) and applying coagulants through the chemical dosing unit (5). The AI-based optimization module dynamically adjusts the type and quantity of chemicals used, based on real-time analysis of sludge properties. This improves the formation of flocs, enhancing separation efficiency and reducing operational costs.

The chemical dosing unit (5) is responsible for precise chemical application in the coagulation tank (4), and its operation is governed by real-time data processed by the AI-driven processing unit (10). Machine learning models predict the optimal chemical dosage needed based on sludge characteristics, ensuring effective treatment while minimizing chemical usage and waste.

The centrifuge (9) receives treated sludge from the coagulation tank (4) and further enhances solid-liquid separation by employing centrifugal force. The AI-driven processing unit (10) monitors centrifuge parameters, such as rotational speed, and makes real-time adjustments based on incoming sludge characteristics to optimize the separation process.

The solid-liquid separation unit (7) further processes the liquid separated by the centrifuge (9) using advanced filtration techniques. The system dynamically adjusts filtration throughput and membrane cleaning cycles based on contaminant levels detected by the processing unit (10). This ensures that the treated effluent meets quality standards and achieves maximum filtration efficiency.

The secondary collection tank (8) temporarily stores treated liquid from the solid-liquid separation unit (7) before it is sent to the chlorination unit (9) for disinfection. The processing unit (10) monitors the tank's liquid levels and triggers alerts for any discrepancies, ensuring that the chlorination process operates efficiently without disruptions.

The chlorination unit (9) disinfects the treated effluent by applying chlorine or chlorine-based compounds. AI-driven sensors monitor the water quality in real time and dynamically adjust chlorine dosage to ensure optimal disinfection while minimizing chemical usage. This guarantees that the final effluent complies with water quality standards.

The processing unit (10) integrates real-time data from the system's various components, including the coagulation tank (4), centrifuge (6), and filtration unit (7), to optimize the entire treatment process. The AI-based optimization module employs machine learning models to continuously adapt system parameters such as chemical dosing, centrifuge speed, and filtration throughput based on real-time data and historical performance metrics.

The communication network (11) facilitates real-time data transmission between the system components, including sensor readings and performance metrics. This network supports multiple communication protocols, such as Bluetooth and Wi-Fi, allowing seamless integration, remote monitoring, and control of the system.

The user interface (12) enables operators to interact with the system easily by providing real-time performance monitoring, system alerts, and manual control options. The interface is designed for intuitive use, ensuring that operators can efficiently manage system parameters and respond to operational anomalies.

The filtration unit of the septage treatment system is in the final stages of liquid refinement, ensuring the quality of the treated effluent. After the solid-liquid separation process, the filtered liquid is directed to the filtration unit, which utilizes advanced technologies such as ultrafiltration membranes to remove any remaining contaminants. The processing unit, integrated with machine learning models, continuously monitors real-time data such as contaminant levels and adjusts the filtration parameters, including flow rates and membrane cleaning cycles, to maintain optimal performance. This dynamic adjustment ensures that the filtration process operates efficiently, adheres to environmental standards, and produces high-quality effluent suitable for safe disposal or reuse.

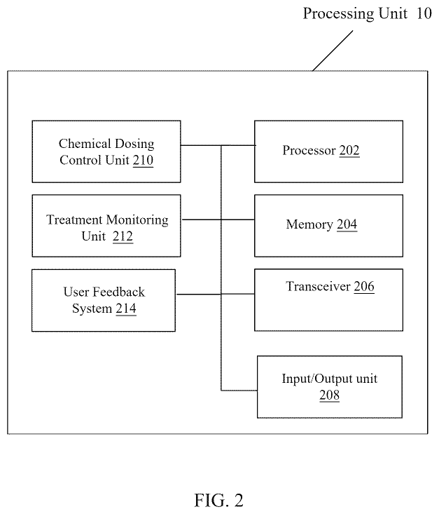

FIG. 2 illustrates the architecture of a processing unit (10) of the present system, in accordance with an embodiment of the present invention. The processing unit (10) is configured to support the septage treatment system, designed to manage the treatment process with high efficiency. This unit includes a processor (202), memory (204), transceiver (206), and an input/output unit (208), each interacting seamlessly with multiple sensors, including chemical sensors and flow meters. The sensors monitor parameters such as chemical dosage, liquid levels, and environmental factors that influence the treatment system's operational efficiency. The components within the processing unit include the chemical dosing control unit (210), treatment monitoring unit (212), and user feedback system (214). These units ensure optimized data processing, real-time decision-making, and user interaction, facilitating precise treatment control and operational feedback. The processor (202) is also responsible for communicating via the transceiver (206) with the communication network (11), enabling efficient data flow and system coordination.

The processor (202) is embedded with logic, circuitry, and interfaces to execute the instructions stored in memory (204), enabling it to manage various treatment stages. This processor integrates multiple technologies, including X86, RISC, and ASIC, which ensure high-speed data processing and operational accuracy. In conjunction with the memory (204), transceiver (206), and input/output unit (208), it monitors and controls various sensors, including chemical sensors for dosing control and flow meters for liquid level assessment. Additionally, the processor (202) coordinates the activities of the chemical dosing control unit (210), treatment monitoring unit (212), and user feedback system (214) to ensure the system operates efficiently and meets the required treatment standards.

The memory (204) contains the logic, circuitry, and interfaces required to store the instructions executed by the processor (202). It is programmed to retain routines and scripts for monitoring and controlling the treatment process, including dosage calculations and sensor data analysis. This memory can be implemented using various forms, such as RAM, ROM, or external storage, ensuring both secure and robust data handling. It stores operational data, treatment protocols, and sensor readings that support real-time system adjustments, enhancing the precision of treatment stages like coagulation and separation.

The transceiver (206) facilitates real-time communication between the sensors and the processing unit (10), ensuring the treatment system can dynamically adjust based on real-time data. The transceiver collects data from chemical sensors, flow meters, and environmental sensors, transmitting it through the communication network (106) for analysis. It supports a range of communication technologies, including Wi-Fi, Bluetooth, and cellular networks, ensuring seamless data exchange both within the system and with external monitoring platforms. This real-time data transmission allows for efficient remote access, control, and timely updates for optimizing the septage treatment process.

The input/output unit (208) provides a user interface for interaction with the septage treatment system. The input devices may include touchscreens or manual override switches, while output devices consist of indicators for system status, alarms for any abnormalities, and reports on treatment efficiency. These components provide real-time feedback, helping operators monitor system performance and make informed decisions about adjustments. The processor (202) communicates with this unit to ensure that users are informed about operational conditions and potential issues, facilitating effective system management and enhancing decision-making processes.

The chemical dosing control unit (210) is responsible for managing the precise application of coagulants and flocculants during the treatment process. This unit receives data from chemical sensors to optimize the dosage according to the characteristics of the incoming septage. By employing advanced algorithms and real-time data monitoring, the control unit ensures that the chemical application is both efficient and minimal, reducing waste and improving treatment effectiveness. The system dynamically adjusts chemical usage based on sensor feedback, thereby optimizing resource use and maintaining high treatment standards.

The treatment monitoring unit (212) oversees the various stages of the treatment process, including coagulation, solid-liquid separation, and effluent disinfection. By continuously collecting data from flow meters, chemical sensors, and effluent quality sensors, this unit provides a comprehensive view of system performance. It analyzes this data to optimize treatment efficiency and can trigger alerts for maintenance or operational adjustments if necessary. The unit ensures that the septage treatment system meets environmental regulations and operates at peak efficiency.

The user feedback system (214) allows operators to interact with the septage treatment system, providing input regarding system performance and preferences for treatment parameters. This system collects user-generated feedback on the effectiveness of the treatment process and provides real-time updates regarding system status and required actions. By incorporating user feedback into the operational framework, the system ensures that the treatment process aligns with the operators'needs and enhances overall system efficiency.

In an exemplary operation, a system to treat and manage septage operates by leveraging a series of interconnected components that optimize the entire process from monitoring to treatment execution. The system comprises a processing unit configured with a processor, memory, transceiver, and input/output unit that interface with various sensors, including chemical sensors for monitoring coagulant and flocculant dosage and flow meters for assessing liquid levels. The system further comprises a chemical dosing control unit responsible for precise dosing adjustments based on sensor feedback, a treatment monitoring unit to oversee coagulation, separation, and disinfection stages, and a user feedback system that enables real-time interaction with operators. In an embodiment, the processing unit receives real-time data from the sensors and utilizes advanced algorithms to adjust chemical dosages accordingly. In an embodiment, the transceiver facilitates seamless communication between the system and external monitoring platforms via Wi-Fi, Bluetooth, or cellular connectivity, ensuring remote access and control. In an embodiment, the memory stores operational protocols and sensor data, supporting continuous and secure monitoring. In an embodiment, the input/output unit provides a user-friendly interface for system control, with visual indicators, alarms, and real-time feedback to enhance decision-making during the treatment process.

In an embodiment, the processor is configured to receive real-time data from the coagulation tank, centrifuge module, and filtration unit. In an embodiment, the processor is configured to adjust operational parameters, including chemical dosing concentration, centrifuge rotational speed, and filtration throughput, based on real-time data and historical performance metrics. In an embodiment, the processor is configured to employ a machine learning model to dynamically adapt treatment protocols for optimizing system performance. In an embodiment, the processor is configured to store treatment protocols and historical system performance data in a memory unit for future adaptive optimization. In an embodiment, the processor is configured to generate real-time alerts for operational anomalies via a user interface, enabling remote control and manual adjustments to system parameters. In an embodiment, the processor is configured to monitor inefficiencies or malfunctions within the treatment stages and provide diagnostic feedback for corrective actions. In an embodiment, the processor is configured to dynamically adjust filtration throughput and membrane cleaning cycles based on contaminant levels detected during the treatment process.

In another embodiment of the present invention, the septage treatment system incorporates an AI-driven optimization module that continuously monitors and analyzes the characteristics of incoming septage, including organic load, nutrient content, and contaminant levels. The system begins by extracting septage from a septic tank using a sewage pump, passing it through a screen filter that separates solid sludge from liquid. The sludge is transferred to a coagulation tank, where treatment chemicals are applied via a chemical dosing unit, with the dosage dynamically adjusted by the AI model based on real-time data. The treated sludge is then processed in a centrifuge to separate the remaining solids from liquids, while the liquid undergoes further filtration to remove residual contaminants. The system continuously adjusts operational parameters such as chemical dosing, centrifuge speed, and filtration efficiency based on both real-time and historical data stored in the system's memory. The system also features predictive maintenance capabilities, using AI to anticipate equipment failures, optimize maintenance schedules, and minimize downtime. Finally, a chlorination unit ensures that the treated effluent meets regulatory water quality standards, with AI sensors providing real-time feedback and system optimization.

In yet another embodiment of the present invention, the AI-driven septage treatment system includes an integrated sensor network that monitors key parameters such as pH, temperature, and contaminant concentration at various stages of the treatment process. Septage is first extracted and passed through a screen filter to remove large solids, and the remaining sludge is sent to a coagulation tank where chemicals are added via a dosing unit. The AI module dynamically adjusts the chemical dosage based on real-time analysis of sludge composition and historical treatment data. Following coagulation, the septage is processed through a centrifuge for solid-liquid separation, with the liquid stream directed to a filtration unit for further purification. The system's AI-driven optimization module continuously fine-tunes centrifuge speed and filtration rates to maximize efficiency. Additionally, the system leverages predictive analytics to monitor equipment health, including pumps and filters, providing maintenance alerts before potential failures occur. The treated effluent is chlorinated, and the system's AI sensors ensure compliance with water quality standards, adjusting the chlorine levels as necessary to maintain optimal disinfection.

Let us consider a practical scenario to illustrate the workings of the present invention. Imagine a wastewater treatment facility that receives septic tank effluent from a nearby residential area. Upon arrival, the septage is pumped into the system, where it first passes through a screen filter to remove large solids. The remaining sludge, characterized by varying levels of organic content and nutrient concentration, is directed into a coagulation tank. Here, the AI-driven optimization module analyzes the sludge's composition in real time and determines the optimal chemical dosage to apply through the dosing unit, ensuring effective coagulation. After treatment, the sludge moves to a centrifuge, which efficiently separates the solids from the liquids. The separated liquid is then sent to a filtration unit, where residual contaminants are removed. Throughout the process, the system continuously monitors key parameters and adjusts operational settings, such as centrifuge speed and filtration throughput, based on real-time data. Additionally, predictive maintenance alerts are generated to preemptively address equipment issues, ensuring smooth operation. Finally, the treated effluent undergoes chlorination, with AI sensors confirming that the final output meets the necessary water quality standards before it is discharged or reused, demonstrating the system's efficiency and effectiveness in treating septage.

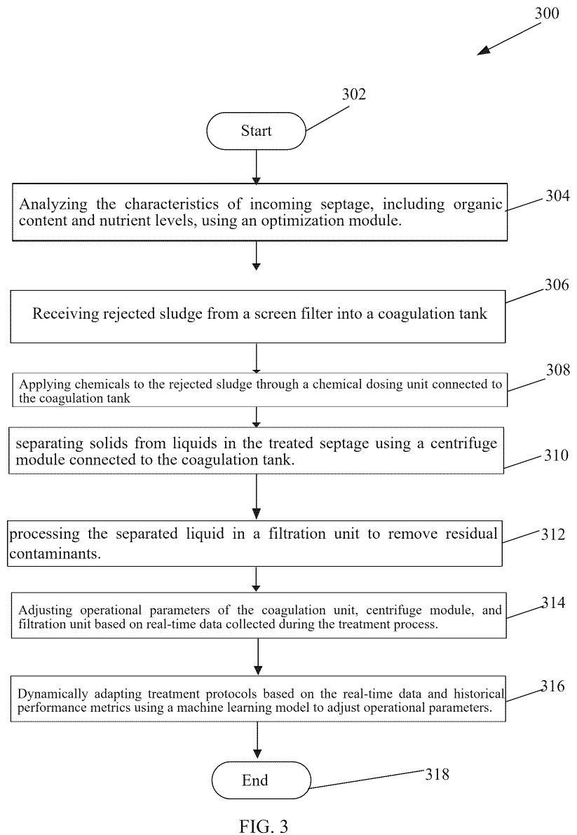

FIG. 3 is a flowchart that illustrates a method for treating septage using an AI-driven optimization process, in accordance with an embodiment of the present invention. The method begins in a Start step 302 and proceeds to step 304. At step 304, the characteristics of incoming septage, including organic content and nutrient levels, are analyzed using the AI-driven optimization module. The process then moves to step 306, where the rejected sludge from a screen filter is received into a coagulation tank. At step 308, chemicals are applied to the rejected sludge via a chemical dosing unit, with the dosage optimized based on real-time data analysis. The method continues to step 310, where the sludge is processed in a centrifuge to separate solids from liquids. Next, at step 312, the separated liquid is directed to a filtration unit to remove any residual contaminants. In step 314, the operational parameters of the coagulation unit, centrifuge module, and filtration unit are adjusted based on real-time data collected during the treatment process. Finally, at step 316, the treatment protocols are dynamically adapted using a machine learning model, which adjusts parameters such as chemical dosing concentration, centrifuge rotational speed, and filtration throughput based on historical performance metrics. The method concludes at the End of step 318.

At Step 304 involves the analysis of the incoming septage characteristics, focusing on key parameters such as organic content and nutrient levels. Utilizing advanced AI models, the optimization module processes data from various sensors installed throughout the system. This real-time analysis not only enables accurate assessments of the septage composition but also allows for the identification of specific treatment requirements, ensuring tailored processing strategies are employed for optimal efficiency.

At Step 306, the method transitions to receiving the rejected sludge from a screen filter into the coagulation tank. This step is crucial as it ensures that larger solids have already been removed, allowing the coagulation process to focus on smaller particulates and dissolved substances. The transfer of sludge is meticulously controlled to maintain system integrity and ensure consistent flow rates, which are essential for effective treatment.

At Step 308, the method entails the application of chemicals to the rejected sludge via a chemical dosing unit. In this stage, the AI-driven module determines the optimal chemical dosage required for effective coagulation based on the real-time analysis conducted in Step 304. By dynamically adjusting the chemical dosage, the system enhances the coagulation efficiency, minimizing chemical waste while maximizing treatment effectiveness. The AI's ability to adapt the chemical dosing in real-time ensures that fluctuations in sludge characteristics are promptly addressed, thereby optimizing the overall treatment process.

At Step 310, the method focuses on the centrifugation process, where the sludge undergoes separation into solids and liquids. The centrifuge module operates at controlled rotational speeds and conditions to effectively segregate the heavier solids from the lighter liquid fractions. This step is pivotal in reducing the volume of sludge that requires further treatment and facilitates the extraction of clarified liquid for additional purification.

At Step 312, the separated liquid is directed to a filtration unit, which processes the effluent to remove any residual contaminants. This filtration step employs advanced materials and technologies to ensure high levels of purity, further enhancing the quality of the treated effluent. The filtration unit is designed to adapt its operational parameters based on contaminant levels detected, ensuring efficient and effective removal of impurities.

At Step 314, the method includes adjustment of operational parameters for the coagulation unit, centrifuge module, and filtration unit, based on real-time data collected throughout the treatment process. The processing unit continuously evaluates performance metrics and environmental conditions to optimize the functionality of each component, promoting a responsive and adaptive treatment system. This continuous feedback loop enables the system to fine-tune its operations, enhancing efficiency and effectiveness while minimizing energy consumption and operational costs.

At Step 316, the treatment protocols are dynamically adapted using a machine learning model that analyzes historical performance metrics alongside real-time data. This advanced capability allows the system to refine its operational strategies continuously, adjusting key parameters such as chemical dosing concentration, centrifuge rotational speed, and filtration throughput. The AI model learns from previous treatments, allowing for proactive adjustments that enhance system performance and reliability.

The method concludes at Step 318 end, marking the completion of the treatment process. At this stage, the system generates a comprehensive report detailing the treatment efficiency, chemical usage, and final effluent quality, which can be utilized for regulatory compliance and future process improvements. This structured approach ensures that the treatment of septage is not only effective and efficient but also aligns with environmental standards and best practices in wastewater management.

The present disclosure offers several technical advantages over conventional septage treatment systems. Its integration of multiple sensors and AI-driven modules enables real-time analysis of key parameters, such as organic content and nutrient levels, allowing for highly precise chemical dosing and operational adjustments throughout the treatment process. This enhanced level of automation and control significantly reduces chemical waste, optimizes energy consumption, and ensures consistent treatment efficiency, even when faced with fluctuating sludge characteristics. Additionally, the use of machine learning models allows the system to continuously adapt treatment protocols based on historical performance data and real-time monitoring, leading to improved system performance over time. The inclusion of predictive maintenance features further distinguishes the present invention, as it can proactively identify inefficiencies or potential malfunctions in components such as pumps, centrifuges, and filtration units, minimizing downtime and extending equipment life. Moreover, the system's ability to dynamically adjust filtration throughput and membrane cleaning cycles based on contaminant levels ensures high-quality effluent output that complies with regulatory water standards. Together, these advancements position the present invention as a superior, intelligent solution for septage treatment, offering increased operational efficiency, sustainability, and reliability.

The present disclosure provides a concrete and tangible solution to a significant technical problem in the field of septage treatment, addressing inefficiencies in conventional methods through advanced automation, precision, and real-time adaptability. The present disclosure offers specific technical features and functionalities, such as an AI-driven optimization module that continuously monitors and analyzes incoming septage characteristics, including organic content and nutrient levels, enabling dynamic chemical dosing adjustments based on real-time data. The integration of a machine learning model allows the system to adapt treatment protocols by refining operational parameters such as chemical concentration, centrifuge rotational speed, and filtration throughput, ensuring optimal treatment efficiency. The system further incorporates advanced sensors and AI modules for predictive maintenance, proactively identifying potential failures in critical components like pumps, centrifuges, and filtration units, thereby minimizing downtime and improving operational longevity. Additionally, the filtration unit dynamically adjusts its throughput and membrane cleaning cycles based on detected contaminant levels, ensuring high-quality effluent output that complies with stringent water quality regulations. This combination of real-time monitoring, adaptive control, and predictive maintenance makes the present disclosure a highly innovative and effective solution for the challenges faced in modern septage treatment processes.

A person with ordinary skills in the art will appreciate that the systems, modules, and sub-modules have been illustrated and explained to serve as examples and should not be considered limiting in any manner. It will be further appreciated that the variants of the above-disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

We claim:

1. A system for treating septage, the system comprising:
an optimization module configured to analyze the characteristics of incoming septage, including organic content and nutrient levels;
a coagulation tank connected to a screen filter, configured to:
receive the rejected sludge from the screen filter; and
apply chemicals on the rejected sludge through a chemical dosing unit connected to the coagulation tank;
a centrifuge module connected to the coagulation tank, configured to separate solids from liquids in the treated septage;
a filtration unit configured to process the separated liquid to remove residual contaminants; and
a processing unit comprising a processor and memory, wherein the processor is configured to adjust the operational parameters of the coagulation unit, centrifuge module, and filtration unit based on real-time data collected during the treatment process.
a processing unit configured to:
receive real-time data from the coagulation tank, centrifuge module, and filtration unit,
adjust operational parameters, including chemical dosing concentration, centrifuge rotational speed, and filtration throughput, based on real-time data and historical performance metrics, and
employ machine learning model to adapt treatment protocols dynamically;

2. The system of claim 1, wherein the processing unit comprises a memory unit configured to store treatment protocols and historical system performance data for adaptive optimization, and a user interface, configured to provide real-time monitoring of system performance, generate alerts for operational anomalies, and enable remote control and manual adjustments to system parameters.

3. The system of claim 1, wherein the coagulation tank utilizes chemical agents optimized for specific septage characteristics, including organic load and nutrient content, based on real-time data from the processing unit.

4. The system of claim 1, wherein the optimization module employs a machine learning model that continuously adapts treatment parameters, such as chemical dosing, centrifuge speed, and filtration flow rates, based on real-time data and historical records stored in the processing unit's memory.

5. The system of claim 1, wherein the processing unit further comprises diagnostic capabilities, identifying inefficiencies or malfunctions in any of the treatment stages and providing real-time alerts via the user interface for corrective actions, and the filtration unit dynamically adjusts its filtration throughput and membrane cleaning cycle based on contaminant levels detected by the processing unit.

6. A method for treating septage, the method comprising:
analyzing the characteristics of incoming septage, including organic content and nutrient levels, using an optimization module;
receiving rejected sludge from a screen filter into a coagulation tank;
applying chemicals to the rejected sludge through a chemical dosing unit connected to the coagulation tank;
separating solids from liquids in the treated septage using a centrifuge module connected to the coagulation tank;
processing the separated liquid in a filtration unit to remove residual contaminants;
adjusting operational parameters of the coagulation unit, centrifuge module, and filtration unit based on real-time data collected during the treatment process using a processing unit;
receiving real-time data from the coagulation tank, centrifuge module, and filtration unit in the processing unit; and
dynamically adapting treatment protocols based on real-time data and historical performance metrics using a machine learning model to adjust operational parameters, including chemical dosing concentration, centrifuge rotational speed, and filtration throughput.

7. The method of claim 6, further comprising:
storing treatment protocols and historical system performance data in a memory unit of the processing unit for adaptive optimization; and
providing real-time monitoring of system performance, generating alerts for operational anomalies, and enabling remote control and manual adjustments to system parameters via a user interface.

7. The method of claim 6, wherein the coagulation tank employs chemical agents optimized for specific septage characteristics, including organic load and nutrient content, is based on real-time data from the processing unit.

8. The method of claim 6, wherein the optimization module utilizes a machine learning model that continuously adapts treatment parameters, including chemical dosing, centrifuge speed, and filtration flow rates, based on real-time data and historical records stored in the processing unit's memory.

9. The method of claim 6, wherein the processing unit includes diagnostic capabilities for identifying inefficiencies or malfunctions in any treatment stage and providing real-time alerts via the user interface for corrective actions, while the filtration unit dynamically adjusts its filtration throughput and membrane cleaning cycle based on contaminant levels detected by the processing unit.
